(19) United States
(12) Patent Application Publication
(10) Pub. No.: US 2009/0283952 A1
(43) Pub. Date: Nov. 19, 2009

(54) CUTTING BOARD TO PREVENT CROSS CONTAMINATION

(76) Inventor: Jenna Sellers, Delray Beach, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/466,720

(22) Filed: May 15, 2009

Related U.S. Application Data
(60) Provisional application No. 61/053,286, filed on May 15, 2008.

(51) Int. Cl. B23Q 3/00

(52) U.S. Cl. 269/289 R

(57) ABSTRACT

A food cutting board made up of four separate but hinged panels each movable to each other between 180° and in contact at zero degrees providing for four separate clean food cutting surfaces. The device may also include a plurality of magnets for keeping each of the panels in a fixed position relative to each other during certain modes of operation.

### BACKGROUND OF THE INVENTION

1. Field of the Invention

A food cutting board having a plurality of individual integrated cutting board surfaces that can be manipulated and utilized for cutting different foods on different surfaces for hygienic purposes.

2. Description of Related Art

The use of cutting boards for cutting meats, vegetables and other food stuffs in the kitchen is well-known in the prior art. Wooden cutting boards are quite common. However, the use of a single cutting surface can lead to cross contamination of undesirable bacteria from one food to another. It is very important while preparing foods to separate different types of meats, such as chicken, beef and also animals such as fish while cutting and cleaning, so that each of the meats is not cross contaminated by cutting different meats on the same board surface. Vegetables can also be contaminated by bacteria from meat substances or other vegetables. Having to stop and independently clean the cutting surface after each food cutting event is time consuming and can actually interrupt the timely cooking process when certain foods have to be prepared at certain times while cooking.

Multiple cutting board surfaces have been shown in the past. A stacked array is shown in U.S. Pat. No. 7,125,011 issued to McLaughlin Oct. 24, 2006 for a magnetic cutting board. This '011 patent shows one or more cutting boards that are stacked in an array for different cutting surfaces. U.S. Patent Publication 2007/0267800 published Nov. 22, 2007 to Zeng show a multi-purpose cutting board. Individual cutting panels that can be stacked and color-coded for different food stuffs are shown. The device includes open holes that can be registered with pins for alignment on a cutting board surface.

The cutting board disclosed herein provides a single cutting board having integrated multiple cutting surfaces. A plurality of individual cutting board surfaces are hinged together at a common hinge joint. The cutting surfaces can be moved relative to each other, much like a page book fashion, so that four independent clean cutting surfaces can be available during a single cooking event.

### SUMMARY OF THE INVENTION

A food cutting board having an array of integrated individual cutting board surfaces for separately cutting different food stuffs on different surfaces comprising first, second, third and fourth cutting board panels. Each panel has two food cutting surfaces, top and bottom. All four of the cutting board panels being joined at one end to a common hinge that allows two adjacent cutting board panels to be disposed in a first mode that is flat (two adjacent panels from a 180° angle) exposing two available cutting surfaces and a second mode where the board panels and surfaces are in contact with each other in a zero degree configuration.

A total of four independent different cutting surfaces can be formed from one cutting board, each cutting surface made from two panel surfaces at a 180° configuration. The middle hinge joins four panels along one end of each panel. The four panels and hinge joint can be made from a single molded unit.

Each panel free end (opposite the joint) may include a decorative non-cutting surface area that also includes indicia that represents a particular food that is displayed in letters or symbols signifying use of a particular food. Magnets can be mounted in the panel non-cutting surfaces for holding together adjacent panels.

In one operational mode, the cutting board can be manually spread open so that two board panel faces are face up joined by a hinge in a 180° disposition. That board disposition can be flipped over exposing a second set of panel surfaces of cutting board panels that are different surfaces than the first set of exposed boards.

In a third operational mode, the cutting board on either side can be flipped like a page of a book exposing two more surfaces in a 180° fashion that have not been utilized. Finally, in a fourth mode, the opposite side board can be flipped over in a reverse direction exposing two cutting board surfaces that are joined together by the common hinge in a 180° disposition that has another clean surface that has not been used for cutting.

Thus, using the cutting board described herein, four different clean cutting board surfaces are available which can be used for cutting different types of foods such as beef, fish, chicken and vegetables using one board with four different modes of disposition before the board has to be cleaned. The board surfaces in contact may also be held together by magnets that can be connected or molded in the hoards. The boards are made of a suitable rigid plastic. Each board is preferably rectangular, thin and flat on each side and is shaped and sized to be joined at one common end with all four different boards along a hinged portion so that the entire device can be opened and closed panel by panel (each of four boards) joined by a plastic hinge in the center. This disposition and array of board segments allows for four different clean cutting surfaces that are available with each use of the board.

It is an object of this invention to provide a cutting board that has four different clean surfaces available for cutting different foods during a single cooking event.

It is another object of this invention to provide an array of cutting boards that are joined together in a common device that prevents cross contamination between the cutting of different food stuffs.

In accordance with these and other objects which will become apparent hereinafter, the instant invention will now be described with particular reference to the accompanying drawings.

### BRIEF DESCRIPTION OF THE DRAWINGS

FIG. 1 shows a perspective view of the cutting board in a flat 180° disposition.

FIG. 2 shows perspective view of the cutting board in which all four cutting board panels are shown in an open configuration perpendicular to each other.

FIG. 3 shows a perspective view of the cutting board in a non-operational mode while moving the cutting panels.

FIG. 4 shows a perspective view of the cutting board in a non-operational mode.

### PREFERRED EMBODIMENT OF THE INVENTION

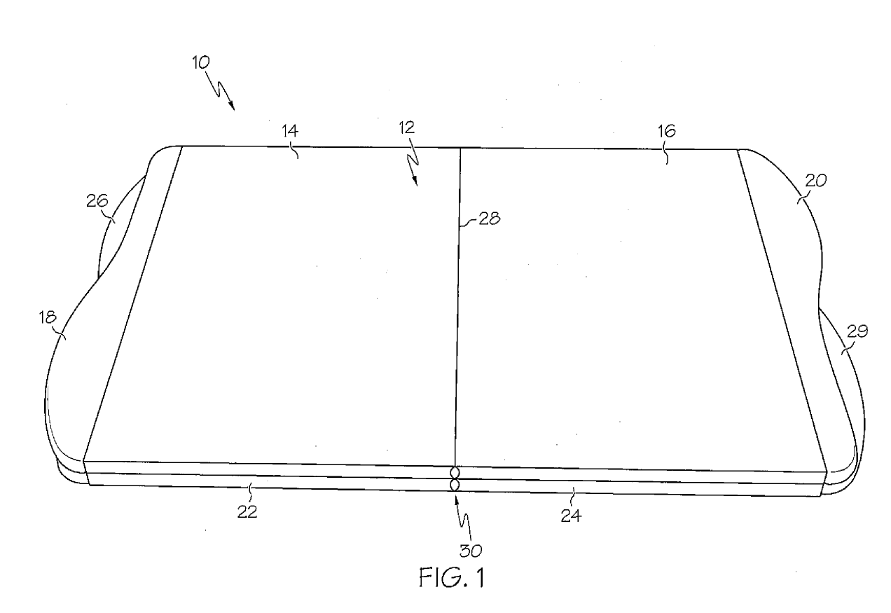

Referring now to the drawings and, in particular, to FIG. 1, cutting board 10 is comprised of four cutting board panels 14, 16, 22 and 24 joined together by a common central hinge 30 that may be integrally molded with the four panels together. The element 28 represents a foldable hinge line that is part of hinge 30 that allows panel 14 and panel 16 to be moved from the 180° position shown in FIG. 1 when the board is flat and panels 14 and 16 are in the same plane to a zero degree position where panel 14 is in direct contact with panel 16. The molded panels 14, 16, 22 and 24 will be made of a very durable plastic that does not easily scratch or cut since there is a cutting board used for cutting food. Each of the panels 14, 16, 22 and 24 have along their outer edge an additional panel segment surface areas 18, 20, 26 and 29 that may include indicia that shows a particular type of food or meat that can easily recognized when the panel is in a flat configuration as shown in FIG. 1. The panel end segments 18, 20, 26 and 29 may also include magnets 18a, 20a, 26a and 29a.

The end surface areas 18, 20, 26 and 29 can be used manually as handles for moving each of the panels 14, 16, 22 and 24 to the desired operating position.

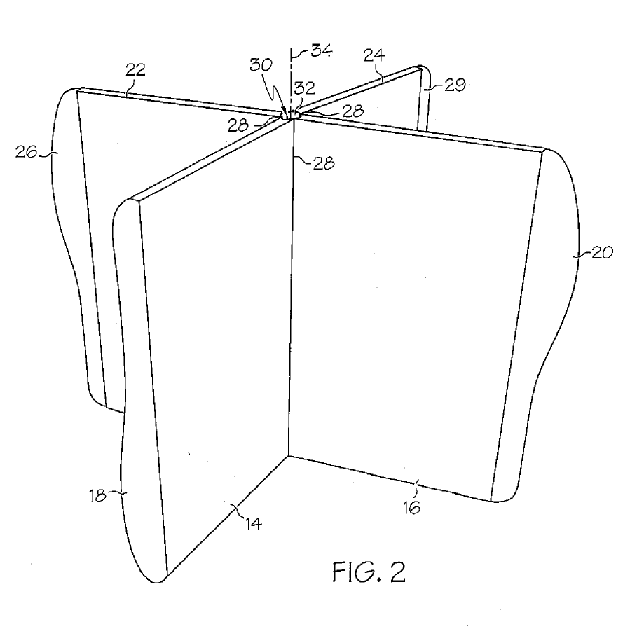

Referring now to FIG. 2, the cutting board is shown such that the hinge joint 30 and the hinge line 28 are mounted vertically with each of the panels 14, 16, 22 and 24 and spread 90° apart and positioned vertically. The position of the cutting board in FIG. 2 is a non-working position that is shown to visualize the four different available cutting surfaces. For example, the top surfaces of 14 and 16 can be manipulated into a 180° flat relationship for a first cutting surface. Likewise, panel 14 and panel 22 can be moved 180° relationship that would be a flat cutting surface. Note, when panel 22 and 14 are moved to 180° relationship, the other two panels also should be opened to 180° relationship such that panel 16 would be in contact with panel 14 and panel 24 would be in contact with panel 22 so that the entire device would be four panels two of which are flat (180°) relative to each other and the two are in contact much as shown in FIG. 1.

Also, as shown in FIG. 2, the original configuration could be flipped over so that cutting panel 24 and 22 provide a flat cutting surface that is 180° apart. Finally, in the fourth mode of operation, panels 24 and 16 are 180° to each other and are flat as are panels 22 and 14. So, again, the configuration looks like FIG. 1 but with different panels arranged 180° to each other.

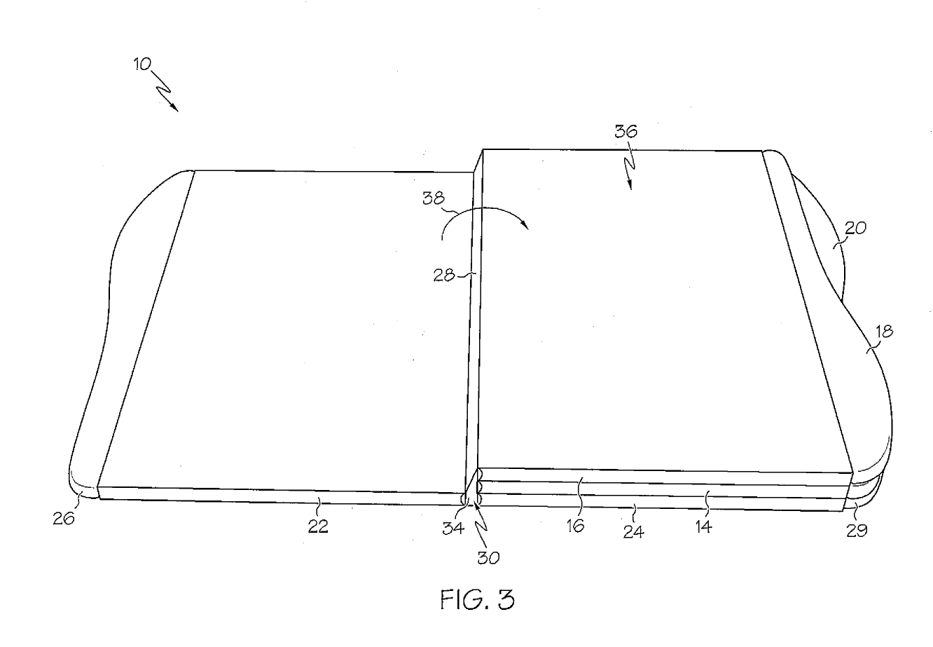

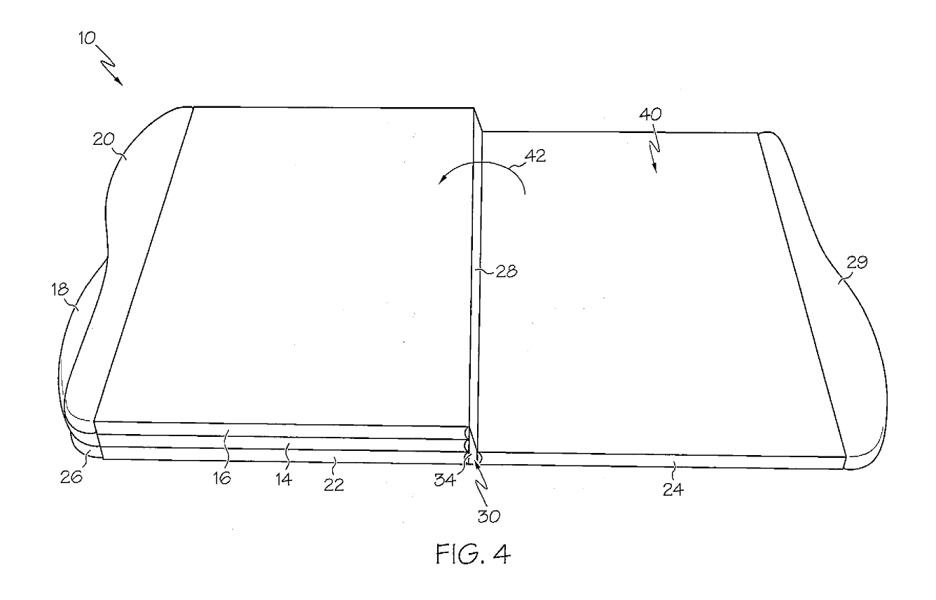

The cutting board as shown in FIG. 3 and FIG. 4 is shown in the in-between stage and is not in an operational position. For example, in FIG. 3, the cutting board 16 should be moved in contact with cutting board 22 creating a configuration much like that shown in FIG. 1. Also, in the mode shown in FIG. 4, panel 16 should be moved into contact with panel 24 creating again a flat configuration as shown in FIG. 1. Each of the panel surface area handles 18, 26, 20 and 29 may have magnets 18a, 26a, 20a and 29a molded inside the handles for contact with each other when the boards are in the operating position such as shown in FIG. 1. This would preclude the boards from accidentally being separated while being moved around the kitchen or on a countertop.

Referring back to FIG. 1, the molded joint 30 is shown schematically and could be formed such that the panels can each move relative to each other between the 180° position to a zero degree position. Typically, however, the four panels will not be stacked on top of each other unless it would be to storage position. The operational mode is more like that shown in FIG. 1 where the two bottom panels 22 and 24 are 180° from each other and are flat and the top panels, 14 and 16, are disposed at 180° angle to each other and are flat. Of course, in one mode of operation, the cutting board shown in FIG. 1 can be used for one food source and then could be directly flipped over for a clean surface to be used for a different food source.

Of course, the top two panels 14 and 16 can be moved to a zero degree and contact position and the bottom two panels 22 and 24 can also be moved in contact with each other at a zero degree thus allowing the reciprocal panels to provide two different food cutting surfaces on top and on the bottom.

The primary benefit of the present invention is that one is presented with four separate clean cutting surfaces without having to clean each of the surfaces during cooking. Different clean surfaces can be used for separating foods such as different meats that need to be cut during a cooking operation and different vegetables for ease of cooking with high hygiene. The device can also easily be cleaned and stored in a flat position as shown in FIG. 1.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An integrated multi-surface cutting board, comprising
a plurality of stackable panels, each having an interface side and opposing flat, rigid, and durable cutting surfaces suitable for cutting selected foods, said plurality of stackable panels providing multiple different cutting surfaces through manual alignment of adjacent panels;
a flexible panel connector comprising a hinge including panel hinge joints;
the interface side of each panel connected together by the flexible panel connector to form a hinge axis, wherein said hinge axis provides a pivot in which the panels are manually movable about; and
wherein two or more adjacent panels are settable at a 180 degrees configuration relative to each other about the hinge axis to form a composite cutting surface.

2. The cutting board of claim 1, wherein the cutting board comprises four panels.

3. The cutting board of claim 1, wherein an additional edge section is attached to the each panel opposite the interface side.

4. The cutting board of claim 3, wherein one or more magnets are mounted into the edge section of each panel, said magnets facilitating two or more panels to be removably stacked together and held together magnetically at a zero degrees configuration relative to each other about the hinge axis.

5. An integrated multi-surface cutting board, comprising
four stackable panels, each having an interface side and opposing flat, rigid, and durable cutting surfaces suitable for cutting selected foods, said plurality of stackable panels providing multiple different cutting surfaces through manual alignment of adjacent panels;
a flexible panel connector comprising a hinge including panel hinge joints;
the interface side of each panel connected together by the flexible panel connector to form a hinge axis, wherein said hinge axis provides a pivot in which the panels are manually movable about;
wherein two or more adjacent panels are settable at a 180 degrees configuration relative to each other about the hinge axis to form a composite cutting surface;
wherein an additional edge section is attached to the each panel opposite the interface side; and
wherein one or more magnets are mounted into the edge section of each panel, said magnets facilitating two or more panels to be removably stacked together and held together magnetically at a zero degrees configuration relative to each other about the hinge axis.
